(19) United States
(12) Patent Application Publication
(10) Pub. No.: US 2026/0270675 A1
(43) Pub. Date: Sep. 10, 2026

(54) Methods and Systems for Customizing Roaming And Preferred Roaming Lists at a User Equipment

(71) Applicant: T-Mobile Innovations LLC, Overland Park, KS (US)

(72) Inventor: Billy Gene McCracken, JR., Lenexa, KS (US)

(21) Appl. No.: 19/070,249

(22) Filed: Mar. 4, 2025

(51) Int. Cl. H04W 8/12; H04L 41/22; H04W 4/029

(52) U.S. Cl. CPC H04W 8/12; H04L 41/22; H04W 4/029

(57) ABSTRACT

A roaming aggregator system generates roaming data for different roaming network systems based on roaming metadata received from each of the roaming network systems. The roaming aggregator system sends the roaming data with roaming rules to a requesting user equipment (UE). The UE uses the roaming rules to determine whether and how to present offers for roaming service plans from each of the roaming network systems based on the roaming data.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

A device may first attempt to connect to the Internet via the home network, which is the carrier that a user of the device may be subscribed to with a subscription account. The device may connect to the home network using unique identifiers related to the carrier (e.g., a system identifier or network identifier stored on a subscriber identity module (SIM) of the device). If the home network is unavailable, the device may search for other networks with which the carrier has roaming agreements. The roaming agreements may be between different carriers and may allow devices to connect to roaming partner networks for continued service. The device may automatically select a roaming partner network based on the roaming agreements to maintain compatibility and minimize costs for the carrier, while providing connectivity to the user.

### SUMMARY

In an embodiment, the method implemented in a communication system to customize roaming at a user equipment (UE) is disclosed. The method comprises receiving, by a roaming aggregator system, roaming metadata from a plurality of roaming network systems, in which the roaming metadata comprises at least one of an identifier of a roaming network system, one or more roaming service plans offered by the roaming network system, a payment plan for the one or more roaming service plans, a permitted authentication method with the roaming network system, or one or more network attributes provided by the roaming network system. The method further comprises receiving, by the roaming aggregator system, a custom roaming request from the UE, in which the custom roaming request comprises location data describing a location of the UE, generating, by a roaming application executing at the roaming aggregator system, roaming data for one or more of the roaming network systems based on the roaming metadata and the location data of the UE, and transmitting, by the roaming application, the roaming data of the one or more roaming network systems to the UE. The method further comprises obtaining, by a client application at the UE, a roaming rule associated with the one or more roaming network systems based on at least one of the roaming data associated with the one or more roaming network systems or the location data, wherein the roaming rule indicates a condition that, when satisfied, triggers the UE to present the roaming data for the one or more roaming network systems on a display of the UE, displaying, by the client application on a display at the UE, a user interface comprising a plurality of user interface elements, wherein each of the user interface elements indicate the roaming data for each respective roaming network system of the one or more roaming network systems and including a selectable icon for a user to select the respective roaming network system, receiving, by the client application, a selection of the selectable icon associated with the respective roaming network system, and reconfiguring, by the client application, a modem of the UE to connect the UE to a cell site operated by the respective roaming network system.

In another embodiment, the method implemented by a roaming aggregator system to customize roaming at a user equipment (UE) is disclosed. The method comprises receiving, by the roaming aggregator system, roaming metadata from a plurality of roaming network systems, receiving, by the roaming aggregator system, a custom roaming request from the UE, in which the custom roaming request comprises location data describing a location of the UE, and generating, by a roaming application executing at the roaming aggregator system, roaming data for one or more of the roaming network systems based on the roaming metadata and the location data of the UE. The method further comprises obtaining, by the roaming application, a roaming rule associated with the one or more roaming network systems based on at least one of the roaming data associated with the one or more roaming network systems or the location data, wherein the roaming rule indicates a condition that, when satisfied, triggers the UE to present the roaming data for the one or more roaming network systems on a display of the UE, transmitting, by the roaming application, to the UE, the roaming data for the one or more roaming network systems and the roaming rule associated with the one or more roaming network systems, and receiving, by the roaming application, from the UE, selection data describing a selected roaming network system and roaming service plan.

In yet another embodiment, a UE comprises at least one processor, at least one memory coupled to the processor, and a client application, stored in the at least one memory. The client application, when executed by the at least one processor, causes the client application to be configured to receive roaming data for a plurality of roaming network systems from a roaming aggregator system, an identifier of each of the roaming network systems, and one or more roaming service plans offered by each of the roaming network systems, obtain a roaming rule associated with each of the roaming network systems based on at least one of the roaming data associated with each of the roaming network systems or location data describing a location of the UE, and display a user interface comprising a plurality of user interface elements each corresponding to a respective roaming network system, in which each of the user interface elements indicate the roaming data for the respective roaming network system and include a selectable icon for the user to select the respective roaming network system.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a block diagram of a communication network according to an embodiment of the disclosure.

FIG. 2 is a message sequence diagram illustrating a first method for customizing roaming at a user equipment (UE) according to various embodiments of the disclosure.

FIG. 3 is a message sequence diagram illustrating a second method for customizing roaming at a UE according to various embodiments of the disclosure.

FIG. 4 is a flowchart illustrating a first method for customizing roaming at a UE according to various embodiments of the disclosure.

FIG. 5 is a flowchart illustrating a second method for customizing roaming at a UE according to various embodiments of the disclosure.

FIG. 6 is a block diagram of a computer system implemented within the communication network of FIG. 1 according to an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

As mentioned above, a device may automatically select a network to connect to either at start up or as the device travels through different regions, countries, and territories in the world. For example, the device may use a local preferred roaming list (PRL), which is a database or file created by an operations team of the carrier that is responsible for managing roaming agreements. The PRL may contain a ranked list of preferred networks (or preferred roaming partner systems) with which the carrier has an agreement, and the ranked list of networks may be geographic-specific. The operation team of the carrier may create the PRL for all subscriber devices based on factors such as signal compatibility, cost of roaming agreements, and geographic availability. The device may receive the PRL from a core network of the carrier at bootup, and store the PRL in the firmware or memory of the device, such that the PRL may be accessed by the radio software of the device to determine a network connection.

For example, a device may start up and retrieve network configuration data and the PRL from the SIM (electronic SIM (eSIM) or SIM card). The PRL may indicate the home network as the highest priority network on the list (e.g., the device should attempt to maintain a connection to the home network at all times unless the signal strength or quality received form the home network falls below a predefined threshold). The device may identify a home network, for example, by matching the code (e.g., mobile network code (MNC)/mobile country code (MCC)) stored in the SIM with the network information broadcast by nearby cell sites. The device may scan for signals from local cell sites of the home network and select the cell site with the strongest signal for connection to establish a connection with the home network.

The device may continuously monitor signal strength and quality from the home network, and when these metrics fall below the predefined threshold, the device may determine that the home network is no longer viable, and consult the PRL to identify the next highest-priority network allowed in the current location of the device. The device may scan for nearby cell sites again, looking for signals that match identifiers of networks listed in the PRL, and the device may select a cell site to connect to based on a signal strength and quality at the current location that meets or exceeds predefined thresholds. The device may prioritize the network with the highest rank in the PRL, so long as the signals received from the network meets the minimum threshold required. The device may then establish a connection with the cell site from the highest-ranking network in the PRL.

Therefore, the PRL is a fixed list defining the networks that a device may automatically connect to based on a location of the device and based on predetermined agreements between the carrier and roaming partners, the PRL is predefined by an operator at the carrier and then sent to the device for configuration, and the PRL may be universal for all subscriber devices of the carrier. Moreover, when the device switches from the home network to a roaming network, and the device and user may be completely unaware of the service plans and associated costs provided by the roaming networks (i.e., the users may sometimes be blindsided by excessive charges for services offered by the roaming partner because the device automatically connected to the roaming partner network while travelling). Therefore, the networks indicated in the PRL have no relation to the device, the service plan and cost preferences of the user, the behaviors of the users, etc. While PRLs may be updated, the update is still predefined by the carrier and based on agreement updates (e.g., newly added roaming partners), network changes (e.g., network reconfigurations or decommissions), or cost optimization (to reduce carrier operational charges – not to reduce user costs).

The rigidity and fixed nature of PRLs may cause various technical problems, specifically in dynamic or resource-constrained environments. For example, predefined PRLs may give rise to suboptimal network selections (e.g., a fixed PRL may not account for congestion capacity issues – for example, at the network providing services for cruise members), signal overlap confusion in which the device may repeatedly attempt to a higher-priority networks in the PRL, uneven distribution of roaming traffic (e.g., often concentrating on traffic on one roaming network’s infrastructure), inflexibility during peak loads, lack of consideration for device capabilities, limited band support at certain frequency bands or technologies, regional network disparities (e.g., prioritizing a roaming partner network with sparse coverage), etc.

The present disclosure addresses the foregoing technical problems by providing a technical solution in the technical field of network roaming services by enabling users to select a roaming network to connect to based on data received from the roaming network (e.g., based on an offer received from the roaming network), as further described herein. Therefore, rather than relying on a predefined PRL to govern how and when to switch network connections, the embodiments disclosed herein enable users to intelligently select roaming networks to switch to based on data provided by the roaming network (e.g., service plan data, payment options, network attributes, current network conditions, etc.). In this way, networks and devices may perform a more optimal network selection process (e.g., based on the services/quality provided by the roaming network, the current network conditions, etc.) that is more suited to the user preferences (e.g., billing preferences, cost preferences, etc.). Moreover, since the device is likely to connect to more optimal roaming networks that meet the user demands, the device is far less likely to repeatedly and unnecessarily attempt to connect to higher-priority networks in the PRL, thereby increasing the overall network capacity across all networks (e.g., the home network and the roaming networks). In this way, the embodiments disclosed herein may enable devices to create customized PRLs instead of predefined PRLs, in which the customized PRLs are based on user preferences as opposed to carrier requirements and carrier cost considerations.

In an embodiment, a communication system that is configured to provide customized roaming for devices may include one or more devices (e.g., user equipment (UE)), a roaming aggregator system, a home network system, and one or more roaming network systems. The devices may each include a client application and be programmed to enable users to select a desired network to connect to based on data describing roaming service plans received from the home network and/or the roaming network systems. The roaming aggregator system may be owned and operated by a telecommunications carrier (e.g., of the home network system). The roaming aggregator system may include a roaming application and a data store configured to maintain roaming data received from and associated with various roaming network systems (including the home network system), each of which have provided roaming offers describing roaming service plans to the roaming aggregator system. The data store may also store user data describing the device, the location of the device, and a history of the roaming network selections made at the device.

In some embodiments, the roaming aggregator system may first receive roaming metadata from one or more roaming network systems. The roaming metadata may be based on offers provided by roaming partners (engaged in agreements with the carrier) or fall back network partners (not engaged in agreements with the carrier). The offers may include data describing a roaming service plan (e.g., with telecommunications services) that may be provided by the roaming network system to roaming devices, the associated cost of the services to the user, and a payment plan for the telecommunications services offered by the roaming network system. To this end, the roaming metadata received from the roaming network systems may include an identifier of the roaming network system, one or more roaming service plans offered by the roaming network system, a geographic area associated with each of the service plans, a payment plan for each of the service plans, methods of authenticating with the roaming network system, one or more network attributes provided by the roaming network system (e.g., minimum quality of service (QoS provided), frequency bands, etc.).

The roaming application at the roaming aggregator system may receive the roaming metadata from the different roaming network systems (and receive similar types of metadata from the home network system). The roaming application may store the roaming metadata in the data store. Later, the roaming application may package the roaming metadata with other network-based data and roaming rules to obtain roaming data.

Meanwhile, various devices may be triggered to disconnect from a current network system and attach to a new roaming network system (or home network system). The devices may be programmed to detect a roaming trigger event when, for example, the device is initially powered-up, changed locations from an area served by the home network to an area that is not served by the home network (e.g., there may be less than a threshold of signal strength or signal quality from cell sites of the home network), changed locations to a private network or location served by a mini-cell site (e.g., a cell site on a cruise ship), changed locations to a large-scale moving vehicle (e.g., an airplane or cruise ship), etc. When the device detects the occurrence of a roaming trigger event (e.g., based on a location of the device), the device may be triggered to transmit a custom roaming request to the roaming aggregator system. The custom roaming request may be a request to receive roaming offers (e.g., in the form of roaming data) from multiple roaming network systems that have offered roaming service plans at the geographic location of the device. To this end, the custom roaming request may include location data of the device (e.g., latitude/longitude coordinates, location of a cell site serving/that last-served the device, etc.) and an identifier of the device.

Upon receiving the custom roaming request from the device, the roaming application at the roaming aggregator system may generate roaming data for one or more of the roaming network systems based on the roaming metadata received from the roaming network systems and/or the location of the device. As mentioned above, the roaming data may include the roaming metadata received from the roaming network system (e.g., billing data, authentication data, service data, network attribute data, etc.), an identification of the provider (telecommunications carrier company) from which the roaming metadata (or home network metadata) was received, cell site data (e.g., identifying and/or describing the locations of the cell sites of the roaming network system that may serve the location of the device, a signal strength of the signals received from the cell sites, a signal quality of the signals received from the cell sites, etc.), coverage data (e.g., describing the strength of the cellular coverage from the roaming network system received at the location of the device), and/or roaming rules for instructing the UE to generate custom PRLs and display details regarding offers received from the roaming network systems.

In an embodiment, the roaming data for the roaming network system may also include one or more roaming rules. A roaming rule may refer to logic or code that may indicate a condition, which when satisfied, may trigger a client application at the device to perform a predefined task (e.g., include a roaming network system in a custom PRL, exclude a roaming network system from a custom PRL, present the roaming data (in human-readable form) as an offer by the roaming network system on a user interface for display at the device, refrain from presenting the roaming data for display at the device, etc.). In some cases, the roaming rules may be based on user preferences selected or input at the device via a user interface and then transmitted to the roaming aggregator system to generate the roaming rule. Alternatively, the roaming rules may be generated at the device-side based on user preferences selected or input at the device, and then transmitted to the roaming aggregator system.

For example, a roaming rule may indicate different minimum/maximum thresholds (e.g., for signal strength, signal quality, latency, or other network attribute) for specific roaming network systems, such that when the network attribute passes the threshold, the device may detect a roaming trigger event. For example, the signal strength may be measured based on a received signal strength indicator (RSSI) or reference signal received power (RSRP) of a signal received from a network system. For example, the signal quality may be measured based on a signal-to-noise ratio (SNR) or a reference signal received quality (RSRP) of a signal received from a network system.

As another example, a roaming rule may indicate that when the device enters a location area associated with a mini-cell site, the device should not present roaming data associated with the roaming network system operating the mini-cell site and/or the device should not connect to the mini-cell site. As should be appreciated, these roaming rules may also apply to connections with the home network system. For example, the roaming rule may indicate that when the device is located in certain predefined locations within the nation, the device should present roaming data for other roaming network systems available for connection at the predefined location (even when the device has a sufficiently strong cellular connection with the home network system).

In an embodiment, the roaming application at the roaming aggregator system may package the roaming data, including the roaming rules, specifically for the device based on the location of the device, and then transmit the roaming data to the device. In another embodiment, the roaming rules may not be generated by the roaming application at the roaming aggregator system and sent down to the device. Instead, the roaming application may package all the roaming data, excluding the roaming data, and transmit the roaming data to the device. In this embodiment, the device may generate the roaming rules based on the received roaming data for different roaming network systems, user preferences input by the user, and the location of the device.

In either case, once the roaming rules have been obtained (e.g., either received from the roaming aggregator system or generated at the device), a client application at the device may generate a user interface with a user interface element for each of the different roaming network systems for which the roaming data was received. For example, the user interface element for a first roaming network system may include details regarding an offered roaming service plan (e.g., 500 minutes and 50 megabytes of data for 5 days, for $X pre-paid or post-paid), the user interface element for a second roaming network system may include details regarding an offered roaming service plan (e.g., unlimited data, $0.10 a minute, for 30 days, for $X pre-paid or post-paid), and so on. In some cases, the user interface elements may also display the network attributes (e.g., QoS parameters) provided by the roaming network system, information describing the cell sites with above a threshold signal strength/quality level, an indication of the cellular coverage provided by the roaming network system at the location of the device, etc. The data displayed at the user interface element for a roaming network system may be based on the roaming data (e.g., the cell site data, coverage data, billing data, authentication data, service data, network attribute data, etc.) of the roaming network system. The client application may include rules and/or logic for converting the roaming data received from the roaming aggregator system (e.g., in the raw data form) into a human-readable form that is easy to digest and view on a display of a device (e.g., as a roaming rule).

Each user interface element may include selectable icons or elements, which may be used to request further information from the roaming network or select the respective roaming network system with which to initiate a connection. The user interface element may in some cases also include an element by which a time and/or date may be entered, to further specify a time and data at which to initiate the connection with the respective roaming network system.

Each of the user interface elements for each of the roaming network systems may be presented on the display in various manners, which as should be appreciated should not be limited herein. For example, the different user interface elements for each of the roaming network systems may be presented as a scrollable list (vertically or horizontally), a list that can be scrolled through via selection (e.g., one window may display a user interface element for a first roaming network system, and the window may switch to the next user interface element for a second roaming network system upon receiving a selection of a “next” or arrow icon). In some cases, the user interface elements may each list only basic information regarding each plan offered by each roaming network system (e.g., an identification/name of the provider and a price offered), and the user may select an icon to display additional information regarding the plan and the roaming network system.

Once the user selects an icon to initiate a connection with a roaming network system, the device may be triggered to begin the process of tearing down the connection with the home network system or the prior roaming network system (if not already torn down) and establishing a connection with the selected roaming network system. To establish a connection with the selected roaming network system, the client application at the device may reset a modem (e.g., baseband processor, or other data connection hardware equipment or software program) at the device. The device may then listen for incoming broadcast signals from cell sites of the selected roaming network system, by scanning the signals to determine whether the signals contain the identifiers (e.g., MMC or MNC) of the selected roaming network. The device modem may then use protocols to establish a connection to the cell site of the selected roaming network system providing the strongest signal connection with the highest signal quality. For the home network, this may involve authentication/registration with the core network.

The client application at the device may then send selection data regarding the selected roaming network system to the roaming aggregator system. For example, the selection data may indicate the identification of the provider operating the roaming aggregator system, the connected cell site, the signal strength and quality from the cell site, a time/date of establishing the connection, etc. The roaming application may use the selection data to train a predictive model (e.g., large language model, deep learning model, neural networking model, or other artificial intelligence-based predictive model) to make accurate predictions on the roaming networks that may be selected by the user/device in the future at similar locations.

In an embodiment, the selected and/or rejected roaming network systems/service plans may be used to generate a custom PRL at the device. The custom PRL may be a data structure indicating a prioritized list of roaming network systems with which the device may initiate a connection. Unlike the baseline PRL that is predefined by the carrier, the custom PRL may be entirely based on the user preferences, roaming rules, and network selection history at the device. The custom PRL may not even necessarily indicate the home network as the highest priority network if a roaming rule indicates a user preference as such.

In this way, the embodiments disclosed herein serve to more optimally determine network systems with which to initiate a connection at devices based on user preferences and roaming rules created according to the user preferences. Therefore, in general, the embodiments disclosed herein also serve to increase network capacity by decreasing repeated attempts to connect to different networks with perhaps a lower cost and/or a higher priority.

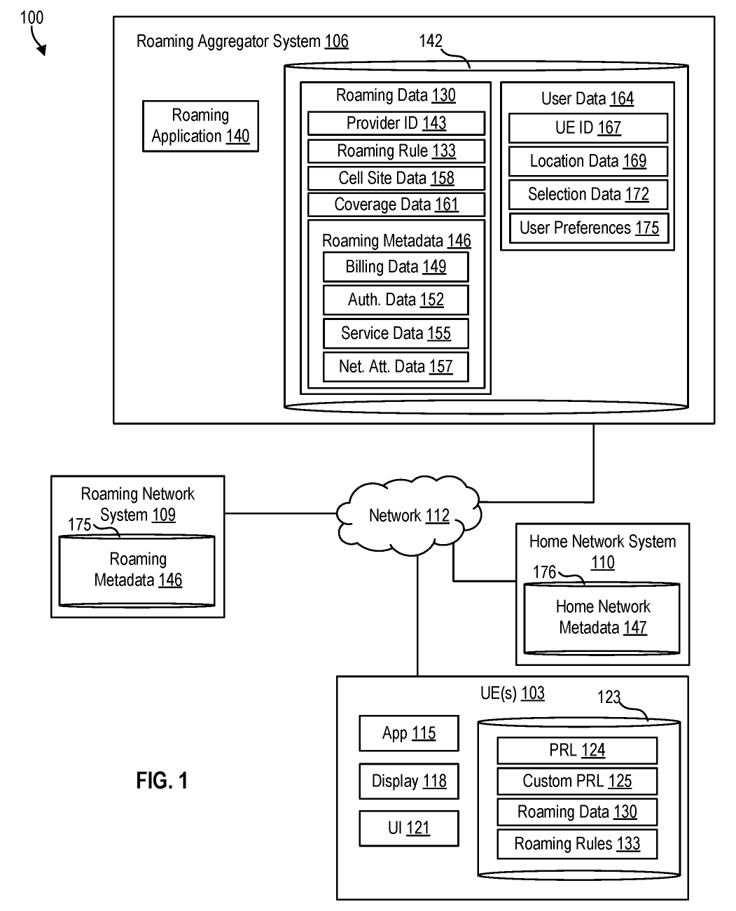

Turning now to FIG. 1, a communication network 100 is described. The communication network 100 comprises a UE 103, a roaming aggregator system 106, one or more roaming network systems 109, a home network system 110, and a network 112. The network 112 may be one or more private networks, one or more public networks, or a combination thereof. While the roaming aggregator system 106, roaming network systems 109, and home network system 110 are shown as separate from the network 112, it should be appreciated that the roaming aggregator system 106, roaming network systems 109, and home network system 110 may be part of the network 112.

The UE 103 may refer to a device that may connect to a home network system 110 or a roaming network system 109 to connect to the Internet. The UE 103 may be, for example, mobile phones, cellular-enabled tablets and computers, internet of things (IoT) devices, smart vehicles, wearable devices, etc. The UE 103 may include an application 115 (also referred to herein as a “client application 115”), which may be instructions stored on a memory of the UE 103 and executable by a processor of the UE 103. The application 115 may be used to detect a roaming trigger event, send a custom roaming request carrying location data to the UE 103, receive roaming data 130 from the roaming aggregator system 106, receive and/or generate roaming rules 133 based on the roaming data 130, generate user interfaces (UIs) 121 describing offers received from each of the roaming network systems 109, present the UIs 121 on a display 118 of the UE 103, receive a selection of an offer from a roaming network system 109 via a UI 121, and then connect the UE 103 to the selected roaming network system 109, as further described herein.

The UE 103 may include a data store 123 (e.g., one or more memories). As shown in FIG. 1, the data store 123 may store a PRL 124, which may refer to the predefined list of roaming network systems 109 created by the carrier and based on agreements between the carrier and the roaming partner systems. The data store 123 may also store the custom PRL 125, which may be a data structure storing a prioritized list of roaming network systems 109 (in some cases, including the home network system 110) based on roaming data 130 (for the roaming network systems 109 and home network system 110) received from the roaming aggregator system 106, and based on selections eceived from the user of the UE 103 via the UI 121. The data store 123 may store roaming data 130, which may be based on roaming metadata 146 received from the roaming network systems 109, home network metadata 147 received from the home network system 110, location data 169 describing a location of the UE 103, etc. The data store 123 may also store roaming rules 133, which may be logic or code indicating tasks or actions to perform based on the roaming data 130 and location data 169 of the UE 103. For example, the action may indicate whether or not to present an offer from a roaming network system 109 on a UI 121 for display at the UE 103, whether to add a roaming network system 109 to the custom PRL 125, whether to switch the UE connection from a first network system (e.g., the home network system 110 or a first roaming network system 109) to a second network system (e.g., the home network system 110 or a second roaming network system 109), etc.

The home network system 110 may refer to a mobile network or system owned and operated by a subscriber’s (e.g., user of the UE 103) primary carrier. The home network system 110 may include, for example, a core network (e.g., for authentication, billing, and subscriber data management) and a radio access network (e.g., for connecting UEs 103 to the network). For example, the UE 103 may by default be connected to the home network system 110 based on a SIM at the UE 103 (e.g., the mobile country code (MCC) and/or mobile network code (MNC) of the SIM). As shown in FIG. 1, the home network system 110 may include a data store (e.g., one or more distributed or co-located memories) for storing home network metadata 147. The home network metadata 147 may refer to data describing a subscription plan associated with the UE 103. A subscription plan defines the specific services, allowances, and conditions provided to a subscriber for a cost, and the subscription plan may be managed by the home network carrier. For example, a subscription plan may specify voice services, such as minutes allocation/number of voice call minutes allowed, calling types permitted (e.g., coverage for local, national, international, or roaming calls), VoLTE support (e.g., high-definition voice service capabilities), QoS (e.g., voice call prioritized, guaranteed call quality parameters – jitter/latency thresholds), etc.

A subscription plan may also specify data services, such as, for example, data allowance (e.g., volume of data provided, speed caps, pay-per-usage), speed limits (e.g., guaranteed speeds for different tiers), QoS parameters (e.g., minimum guaranteed speeds, bandwidth allocation, latency thresholds), usage policies, etc. A subscription plan may also specify messaging services (e.g., short message service (SMS)/multimedia message service (MMS) allocation – number of messages allowed, coverage), and roaming services (e.g., roaming allowances – access to voice, data, and/or messaging when roaming, prices). The subscription plan may indicate other types of services offered and limitations (e.g., geographic limits) imposed by the home network carrier, and the cost and billing for all the services provided by the home network carrier. The cost and billing may include subscription feeds (e.g., monthly, prepaid, or postpaid pricing models), overage charges, discounts, or bundles.

The roaming network systems 109 may each be associated with a different roaming network carrier, each of which may be different from the primary subscribed carrier of the UE 103. In some cases, each of the roaming network systems 109 may be operated by roaming network carriers that have a roaming agreement with the home network carrier. The roaming network systems 109 may each include core network infrastructure and a RAN, and may allow subscribers of the home network carrier to access the core network infrastructure and RAN to receive access to telecommunications services from the roaming network systems 109. For example, the roaming network systems 109 may conditionally be able to provide telecommunication services to the UE 103 when the home network system 110 is unavailable or has less than a threshold level of cellular signal quality or strength. In some cases, the UE 103 may receive voice, SMS, and data services from a roaming network system 109, and the roaming network system 109 may report usage back to the home network system 110 for billing and management.

Each roaming network system 109 may include a data store 174 (e.g., one or more memories) for storing roaming metadata 146. The roaming metadata 146 may include data based on offers providing by roaming partners (engaged in agreements with the home network carrier) or fall back network partners (not engaged in agreements with the home network carrier). An offer may refer to a roaming service plan offered by the roaming partner(s) operating the roaming network system(s) 109 for one or more UEs 103 that are roaming into geographic areas that are serviced by the roaming network system(s) 109 and in some cases, not serviced by the home network system 110. A roaming service plan may be tailored to allow the UE 103 to use voice, data, and messaging services provided by the roaming network system(s) 109, for example, while outside the home network system 110 coverage. The roaming service plan may include data describing roaming voice services (e.g., minutes allocation, call types, calling scope, rates), roaming data services (e.g., data allowance, data speed, QoS parameters, usage policies), roaming messaging services (e.g., SMS/MMS allocation, messaging scope, rates), and cost/billing services (e.g., daily passes, pay-per-use, bundles, overage charges, currency/conversion). To this end, the roaming metadata 146 may include, for example, an identifier of the roaming network system 109, one or more (roaming) service plans offered by the roaming network system 109, a geographic area associated with each of the service plans, a payment plan for each of the service plans, a description of methods of authenticating with the roaming network system, one or more network attributes provided by the roaming network system 109 (e.g., minimum QoS, frequency bands, etc.). Each of roaming network system 109 may send roaming offers in the form of roaming metadata 146 to the roaming aggregator system 106.

The roaming aggregator system 106 may be a collection of co-located or distributed servers, with hardware and software resources (e.g., processing, memory, and network) that are configured to aggregate the data received from the roaming network systems 109, home network system 110, and UEs 103 to help users dynamically select an optimal roaming plan. The roaming aggregator system 106 may include a roaming application 140, which may be stored at a memory of the roaming aggregator system 106 and executable by a processor of the roaming aggregator system 106. The roaming application 140 may aggregate roaming metadata 146 received from the roaming network systems 109, aggregate requests received from the UEs 103 and other data pertaining to the UEs 103, and generate new data/rules based on the data received from the roaming network systems 109 and UEs 103, as further described herein.

The roaming aggregator system 106 also includes a data store 142 (one or more co-located or distributed memories) storing data used to customize roaming plans and PRLs at the UEs 103. The roaming application 140 may store roaming data 130 and user data 164 at the data store 142. The roaming data 130 may be based on the roaming metadata 146 received from the roaming network systems 109 and/or a location of the UE 103 requesting custom roaming from the roaming aggregator system 106.

In some cases, the roaming application 140 may receive a custom roaming request from a UE 103 that has detected a trigger event based on the location of the UE 103 (e.g., when the home network system 110 connection is no longer available or has fallen below a threshold cellular signal quality/strength). After receiving the custom roaming request, the roaming application 140 may generate roaming data 130 for one or more of the roaming network systems 109 based on the roaming metadata 146 received from the roaming network systems 109 and location data 169 (e.g., latitude and longitudinal coordinates or a known location of a currently attached cell site) of the UE 103.

The roaming data 130 may include the roaming metadata 146 received from one or more of the roaming network systems 109 (e.g., billing data 149, authentication data 152, service data 155, network attribute data 157, etc.), a provider identifier 143 of each of the roaming carrier (e.g., an identifier of the roaming network system 109) from which the roaming metadata 146 was received, cell site data 158 (e.g., identifying or describing the locations of the cell sites of the roaming network systems 109 that may serve the location of the UE 103, a signal strength (e.g., RSSI, RSRP, etc.) of the signals received from the cell sites, a signal quality (e.g., SNR, RSRQ, etc.) of the signals received from the cell sites, etc.), coverage data 161 (e.g., describing the strength of the cellular coverage from the roaming network systems 109 at the location of the UE 103), and roaming rules 133. The roaming rules 133 may refer to logic or code instructing the application 115 at the UE 103 to perform specific tasks based on the satisfaction of a predefined condition (e.g., include a roaming network system of the roaming network systems 109 in a custom PRL 125, present the roaming data 130 in human-readable form as a UI 121 at the UE 103, refrain from presenting the roaming data 130 to the user of the UE 103, switch from a home network system 110/first roaming network system 109 to a second roaming network system 109, etc.).

As mentioned above, the roaming metadata 146 may include, in part, billing data 149, authentication data 152, service data 155, and network attribute data 157. The billing data 149 may indicate billing plan types (e.g., daily pass, pay-per-use, bundles, predefined rates for voice/data/messaging services, overage charges, etc.), and accepted methods of payment for the services provided by the roaming network systems 109. The authentication data 152 may describe methods of authenticating with the roaming network systems 109 prior to using the services provided by the roaming network systems 109. The service data 155 may include the details of the roaming service plan (e.g., the offer) provided by each of the roaming network systems 109. For example, the service data 155 may include data describing roaming voice services (e.g., minutes allocation, call types, calling scope, rates), roaming data services (e.g., data allowance, data speed, QoS parameters, usage policies), roaming messaging services (SMS/MMS allocation, messaging scope, rates), and cost/billing services (e.g., daily passes, pay-per-use, bundles, overage charges, currency/conversion). As another example, the service data 155 may include a geographic area associated with each of the roaming service plans. The network attribute data 157 may include data describing one or more network attributes provided by the roaming network systems 109 (e.g., minimum QoS parameters – bandwidth, latency, throughput, jitter, etc., frequency bands, etc.) in providing telecommunications services (e.g., voice services, data services, messaging services) to the UE 103 while roaming.

The user data 164 may include data received from the UE 103 or inferred based on communications from the UE 103. For example, the user data 164 may include a UE identifier 167 identifying the UE 103 (e.g., International Mobile Subscriber Identity (IMSI), International Mobile Equipment Identity (IMEI), Mobile Station International Subscriber Directory Number (MSISDN), Mobile Subscriber Identification Number (MSIN), etc.) The user data 164 may also include location data 169 describing a location of the UE 103 at the time a custom roaming request is received from the UE 103. The location of the UE 103 may be the actual longitude and latitude coordinates of the UE 103, the known location of a cell site attached to the UE 103 at the time a custom roaming request is received from the UE 103, Global Positioning System (GPS) coordinates of the UE 103, and/or any other method of locating the UE 103. The user data 164 may also include selection data 172 describing a history of roaming service plans offered by different roaming network systems 109 that were selected by the user of the UE 103 over a historical period of time. The user data 164 may also include user preferences 175, which may have been received from the UE 103 or other device operated by the user. The user may input user preferences into the UE 103 or other device (e.g., that may be logged into a user account), and the user preferences 175 may indicate preferences of the user in connecting to roaming network systems 109. For example, a user preference 175 may indicate that the user desires the lowest cost roaming plan; a user preference 175 may indicate that the user desires the maximum number of allotted SMS/MMS messages while roaming; a user preference 175 may indicate that the user does not wish to connect to mini-cell sites or private networks; or a user preference 175 may indicate that at certain locations, the user prefers to connect to a roaming network system 109 instead of the home network system 110 (even though the UE 103 is currently in a location adequately serviced by the home network system 110).

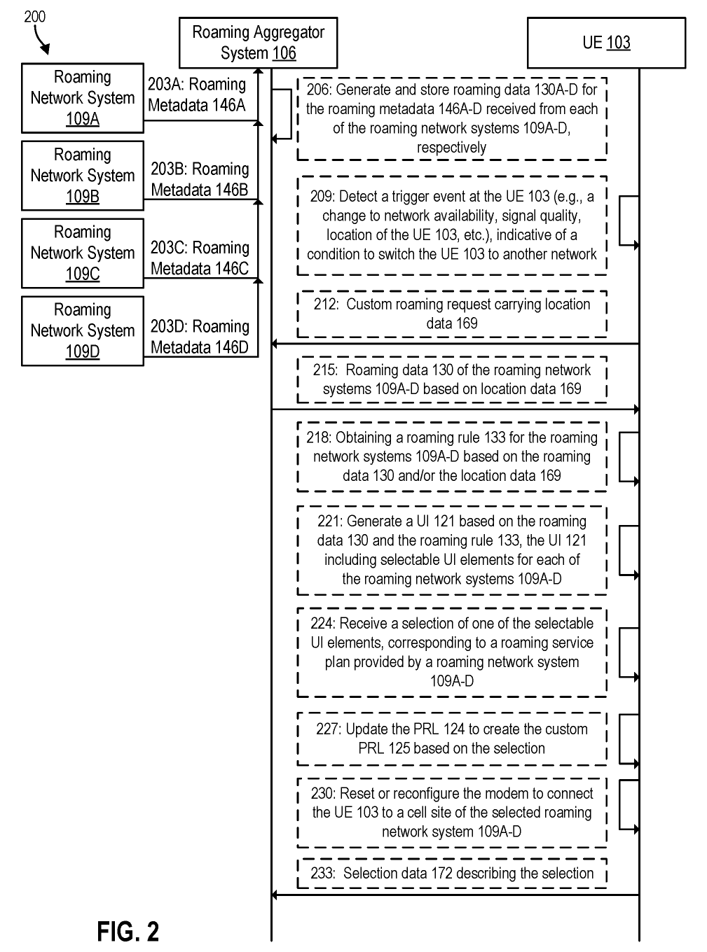

Referring now to FIG. 2, shown is a message sequence diagram illustrating a method 200 for customizing roaming at a UE 103 according to various embodiments of the disclosure. Method 200 may be performed by multiple roaming network systems 109A, 109B, 109C, and 109D, the roaming aggregator system 106, and the UE 103. As illustrated, method 200 of FIG. 2 includes a number of enumerated operations, but embodiments of the operations in FIG. 2 may include additional operations before, after, and in between the enumerated operations. In some embodiments, one or more of the enumerated operations may be omitted or performed in a different order.

Method 200 may begin with the roaming network systems 109A, 109B, 109C, and 109D each transmitting roaming metadata 146A, 146B, 146C, and 146D to the roaming aggregator system 106. Specifically, the roaming network system 109A may perform operation 203A to transmit roaming metadata 146A to the roaming aggregator system 106, and the roaming metadata 146A may include, for example, billing data 149, authentication data 152, service data 155, and network attribute data 157 associated with one or more roaming service offers to be presented to UEs 103 that are roaming into a geographic area served by the roaming network system 109A. The roaming network system 109B may perform operation 203B to transmit roaming metadata 146B to the roaming aggregator system 106, and the roaming metadata 146B may include, for example, billing data 149, authentication data 152, service data 155, and network attribute data 157 associated with one or more roaming service offers to be presented to UEs 103 that are roaming into a geographic area served by the roaming network system 109B. The roaming network system 109C may perform operation 203C to transmit roaming metadata 146C to the roaming aggregator system 106, and the roaming metadata 146C may include, for example, billing data 149, authentication data 152, service data 155, and network attribute data 157 associated with one or more roaming service offers to be presented to UEs 103 that are roaming into a geographic area served by the roaming network system 109C. The roaming network system 109D may perform operation 203D to transmit roaming metadata 146D to the roaming aggregator system 106, and the roaming metadata 146D may include, for example, billing data 149, authentication data 152, service data 155, and network attribute data 157 associated with one or more roaming service offers to be presented to UEs 103 that are roaming into a geographic area served by the roaming network system 109D.

After receiving the roaming metadata 146A, 146B, 146C, and 146D from the roaming network systems 109A, 109B, 109C, and 109D, at operation 206, the roaming application 140 at the roaming aggregator system 106 may generate and store roaming data 130A-D based on the roaming metadata 146A, 146B, 146C, and 146CD received from each of the roaming network systems 109A, 109B, 109C, and 109D (e.g., roaming data 130A may be generated based on the roaming metadata 146A from roaming network system 109A, roaming data 130B may be generated based on the roaming metadata 146B from roaming network system 109B, roaming data 130C may be generated based on the roaming metadata 146C from roaming network system 109C, and roaming data 130D may be generated based on the roaming metadata 146D from roaming network system 109D). The roaming data 130A-D may include the roaming metadata 146A, 146B, 146C, and 146D received from the roaming network systems 109A, 109B, 109C, and 109D respectively, a provider identifier 143 identifying the roaming network partner associated with each of the roaming network system 109A, 109B, 109C, and 109D, cell site data 158 describing, for example, locations and capabilities of the cell sites in the roaming network system 109A, 109B, 109C, and 109D, and coverage data 161 describing the geographic location areas in which the roaming network system 109A, 109B, 109C, and 109D provides, for example, at least a threshold level of cellular signal strength and quality, or has certain frequency bands available.

At operation 209, the application 115 at the UE 103 may detect a trigger event at the UE 103. The trigger event may be a trigger for the UE 103 to, for example, roam from the home network system 110 to roaming network system of the roaming network systems 109A, 109B, 109C, and 109D (e.g., disconnect from the home network system 110 and connect to a roaming network system 109), or to roam from a first roaming network system of the roaming network systems 109A, 109B, 109C, and 109D to a second roaming network system of the roaming network systems 109A, 109B, 109C, and 109D (e.g., disconnect from the first roaming network system 109A and connect to the second roaming network system 109B). The trigger event may be a detected event at the UE 103 based on a location of the UE 103. For example, the trigger event may occur when the UE 103 enters a location where the network availability, signal strength, or signal quality of a currently connected network system (e.g., the home network system 110 or the first roaming network system) falls below a predefined threshold. As other illustrative examples, the trigger event may occur when the UE 103 is initially powered-on, when the UE 103 changes locations from an area served by the home network system 110 to an area not served by the home network system 110, when the UE 103 changes locations to a private network or location served by a mini-cell site (e.g., a cell site on a cruise ship), changed locations to a large-scale moving vehicle (e.g., an airplane or cruise ship), etc. In this way, the trigger event indicates a condition triggering the UE 103 to change connections to another network.

In response to detecting the trigger event, at operation 212, the application 115 at the UE 103 may generate a custom roaming request carrying location data 169 describing a location of the UE 103, and transmit the custom roaming request to the roaming aggregator system 106. The custom roaming request may be a request by the UE 103 for the roaming aggregator system 106 to transmit roaming data 130 describing roaming service offers received from different roaming network systems 109A, 109B, 109C, and 109D that may be available at the current location of the UE 103.

Upon receiving the custom roaming request with the location data 169 of the UE 103, the application 140 at the roaming aggregator system 106 may update the roaming data 130 to include one or more roaming rules 133 based on the location data 169 of the UE 103. The roaming rules 133 may be based on preset user preferences 175 received from the UE 103 at a prior time that may be stored at the data store 142 with the user data 164, the cell site data 158 of each roaming network system of the roaming network systems 109A, 109B, 109C, and 109D, and/or the coverage data 161 of each roaming network system of the roaming network systems 109A, 109B, 109C, and 109D. The roaming rules 133 may again indicate an action or task to perform based on whether a predefined condition is met or satisfied. For example, a roaming rule 133 may indicate that when the UE 103 is located in a geographic area served by a roaming network system, the application 115 at the UE 103 is to present roaming offers to the user at the UE 103 based on the roaming data 130 associated with certain roaming network systems of the roaming network systems 109A, 109B, 109C, and 109D. As another example, a roaming rule 133 may indicate that when the UE 103 enters a private network served by a mini-cell site, the UE 103 is not to connect to the mini-cell site, and the UE 103 is not to present roaming information pertaining to the private network/mini-cell site (this may be based on the user preferences 175). As yet another example, a roaming rule 133 may indicate that when a user selects an interest to learn more about a roaming offer or selects to connect to a roaming network system of the roaming network systems 109A, 109B, 109C, and 109D, the application 115 at the UE 103 may add data describing the roaming network system associated with the selected roaming offer to the custom PRL 125.

At operation 215, the roaming application 140 at the roaming aggregator system 106 may transmit the roaming data 130 for roaming network systems 109A, 109B, 109C, and 109D to the UE 103 based on the location data 169. In an embodiment, only the roaming data 130 of the roaming network systems 109A, 109B, 109C, and 109D that serve the area in which the UE 103 is located is sent to the UE 103 in operation 215. In another embodiment, the roaming data 130 for all the roaming network systems 109A, 109B, 109C, and 109D may be sent to the UE 103, and the UE 103 may select the roaming data 130 based on roaming network systems 109A, 109B, 109C, and 109D that serve the area in which the UE 103 is located.

At operation 218, the application 115 at the UE 103 may obtain (e.g., generate or receive) a roaming rule 133 based on the roaming data 130 and/or the location data 169 of the UE 103. As mentioned above, in an embodiment, the roaming application 140 at the roaming aggregator system 106 may generate the roaming rules 133 and send the roaming rules 133 down to the UE 103. In another embodiment, the roaming aggregator system 106 may transmit the roaming data 130 (without the roaming rules 133) to the UE 103, and the application 115 at the UE 103 may generate the roaming rules 133 in a manner similar to that described above.

At operation 221, the application 115 at the UE 103 may generate a UI 121 based on the roaming data 130 and more specifically, the roaming rule(s) 133 in the roaming data 130. As mentioned above, the roaming rules 133 may specify how and whether the application 115 is to display roaming offers in human-digestible form at the UE 103 based on at least one of user preferences 175 of the UE 103, location data 169 of the UE 103, cell site data 158, coverage data 161, and the roaming metadata 146 associated with each of the roaming network systems 109A, 109B, 109C, and 109D. For example, the roaming rule 133 may include instructions for generating a UI 121 for a roaming network system of the roaming network systems 109A, 109B, 109C, and 109D based on the roaming data 130 associated with the roaming network system, and the instructions may indicate the types of data to present in the UI 121, how to present the data in the UI 121 (e.g., via text or image), text to hide versus text to show in the UI 121, the locations of the data and selectable icons/other user interface elements within the UI 121, etc. For example, the roaming rule 133 may indicate that the UI 121 for a roaming network system of the roaming network systems 109A, 109B, 109C, and 109D is to display a name of the roaming partner associated with the roaming network system (e.g., based on the provider identifier 143), a price and time period associated with the roaming service offered by the roaming network system, and then the voice services (e.g., minutes allotment, calling scope, etc.), data services (e.g., data allowance, QoS parameters, etc.), and messaging services (e.g., SMS/MMS allocation, messaging scope, etc.) offered by the roaming network system. The roaming rule 133 may also indicate conversion parameters used to convert the roaming data 130 into the human-digestible text/images for display at the UI 121. The roaming rule 133 may also indicate the type and placement of selectable UI elements for each of the roaming network systems 109A, 109B, 109C, and 109D, such that the user may select a selectable UI element for a particular roaming network system of the roaming network systems 109A, 109B, 109C, and 109D to either view more data pertaining to the roaming offer or select to connect to the displayed roaming network system based on the displayed roaming offer. In this way, the application 115 may use the roaming rules 133 to generate and display the UI 121 for each of the roaming network systems 109A, 109B, 109C, and 109D based on the roaming data 130 for each of the roaming network systems 109A, 109B, 109C, and 109D.

At operation 224, the application 115 at the UE 103 may receive a selection of one of the selectable UI elements on the UI 121. The selected UI element may be displayed on a UI 121 that also displays data regarding a roaming service plan offered by a roaming network system of the roaming network systems 109A, 109B, 109C, and 109D (based on the roaming data 130 associated with the roaming network system). For example, a UI 121 may display details regarding a roaming service plan offered by a first roaming network system 109A. This UI 121 may include a selectable icon (e.g., UI button, link, check box, etc.), which if selected, indicates that the user would like to connect to the first roaming network system 109A to receive the services at the price offered by the roaming service plan described in the UI 121.

At operation 227, the application 115 may update the PRL 124 (e.g., the carrier defined PRL 124) to create the custom PRL 125 to indicate the roaming network system 109A corresponding to the selected roaming offer at operation 224. For example, the custom PRL 125 may be created by adding the selected roaming network system 109A into the predefined PRL 124 based on the location data 169 (i.e., the location of the UE 103). The priority of the added selected roaming network 109A may be set as the highest priority roaming network (in some cases, below the home network) for the particular location of the UE 103 (e.g., since this roaming network system 109A was selected over others in the area).

At operation 230, the application 115 at the UE 103 may reset or reconfigure the modem (e.g., baseband processor, or other data connection hardware equipment or software program) at the UE 103, and then connect the modem to the selected roaming network system 109A. For example, the UE 103 may detach itself from the current network (e.g., the home network system 110), and the modem may be reconfigured or reset to match the frequency bands, channel settings, and protocols supported by the selected roaming network system 109A (e.g., as indicated in the roaming data 130). The UE 103 may then authenticate and register with the selected roaming network system 109A (e.g., based on the authentication and registration steps indicated in the authentication data 152). The UE 103 may then establish a new connection to the selected roaming network system 109A by setting up new radio bearers to transmit and receive signals and setting up network specific configurations (e.g., frequency bands, encryption settings, QoS parameters, etc. – as indicated in the roaming metadata 146A). The UE 103 may then evaluate the signals received from all cell sites of the selected roaming network system 109A to determine the cell site sending the signal with the highest signal strength (e.g., RSSI or RSRP) and/or the best signal quality (SNR or RSRQ). The modem may select the most optimal cell site based on the signals received from the cell sites and then attach itself to the selected, optimal cell site of the roaming network system 109A.

At operation 233, the UE 103 may generate and transmit selection data 172 describing the selection of the roaming service plan to the roaming aggregator system 106. The selection data 172 may indicate the selected roaming service plan, the roaming network system 109A providing the selected roaming service plan, the location data 169 of the UE 103 at the time of reconnection, an identification/location of the selected, optimal cell site of the roaming network system 109A, a timestamp of disconnecting from the prior network and attaching to the roaming network system 109A, etc. The selection data 172 may be stored with the user data 164 associated with the UE 103.

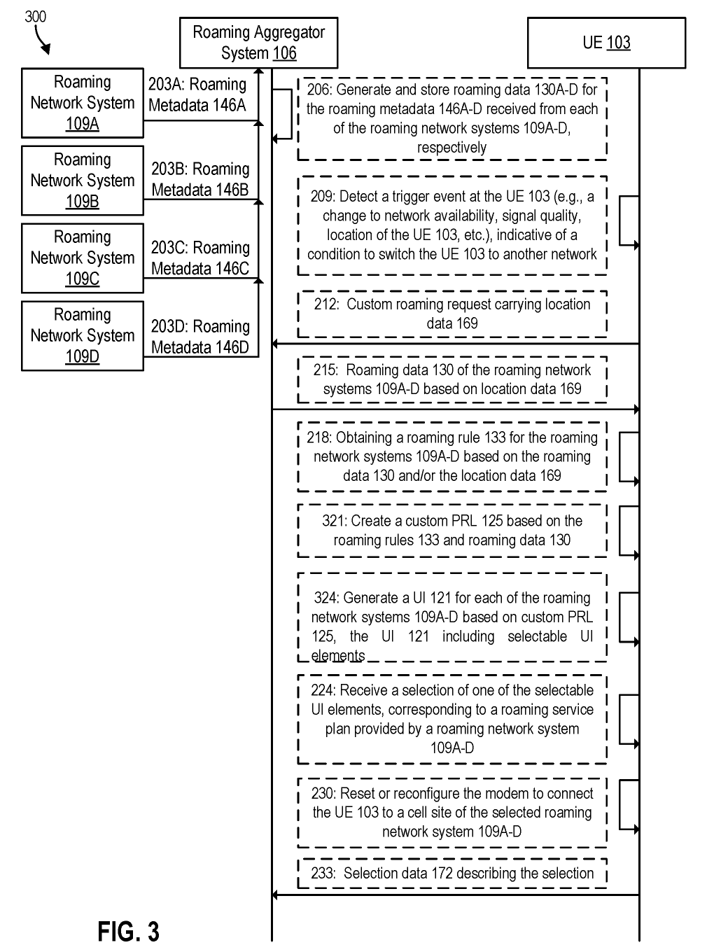

Referring now to FIG. 3, shown is a message sequence diagram illustrating a method 300 for customizing roaming at a UE 103 according to various embodiments of the disclosure. Method 300 may be performed by multiple roaming network systems 109A, 109B, 109C, and 109D, the roaming aggregator system 106, and the UE 103. As illustrated, method 300 of FIG. 3 includes a number of enumerated operations, but embodiments of the operations in FIG. 3 may include additional operations before, after, and in between the enumerated operations. In some embodiments, one or more of the enumerated operations may be omitted or performed in a different order.

Method 300 may include several of the same operations as those described above win method 200 of FIG. 2. For example, like method 200, method 300 may also begin with roaming network systems 109A, 109B, 109C, and 109D performing operations 203A, 203B, 203C, and 203D to transmit roaming metadata 146A, 146B, 146C, and 146D to the roaming aggregator system 106, and the roaming aggregator system 106 may perform operations 206, 209, 212, 215, and 218. Method 300 may proceed similar to method 200 until the roaming aggregator system 106 transmits the roaming data 130 of the roaming network systems 109A, 109B, 109C, and 109D to the UE 103 based on location data 169 of the UE 103, and the application 115 at the UE 103 obtains (e.g., receives or generates) one or more roaming rules 133 for the roaming network systems 109A, 109B, 109C, and 109D based on the roaming data 130 and/or the location data 169 of the UE 103.

Method 300 may then proceed to operation 321, in which the application 115 at the UE 103 creates a custom PRL 125 based on the roaming rules 133 and the received roaming data 130. The roaming rules 133 may indicate whether and how to add roaming network systems 109A, 109B, 109C, and 109D to the custom PRL 125, and the application 115 may use the roaming rules 133 to determine whether and how (e.g., at what priority) to add each of the roaming network systems 109A, 109B, 109C, and 109D indicated in the received roaming data 130 to the custom PRL 125. For example, suppose roaming data 130 for each of the roaming network systems 109A, 109B, 109C, and 109D is received, and a roaming rule 133 may be generated (either at the roaming aggregator system 106 or at the UE 103 based on user preferences 175) to indicate a priority order for different types of roaming service plans offered by each of the roaming network systems 109A, 109B, 109C, and 109D (e.g., based on user preferences 175).

For example, the user preferences 175 may indicate that the user of the UE 103 prefers a low price/rate above all else, and as such, the roaming rule 133 may indicate that the custom PRL 125 should prioritize roaming network systems 109A, 109B, 109C, and 109D based on the price/rate indicated in the roaming data 130 (e.g., lowest price may receive the highest priority). As another example, the user preferences 175 may indicate that the user historically has sent a large quantity of SMS/MMS messages, and as such, the roaming rule 133 may indicate that the custom PRL 125 should prioritize roaming service plans that offer the highest SMS/MMS allotment (e.g., roaming network systems 109A, 109B, 109C, and 109D that offer unlimited SMS/MMS roaming service plans may receive the highest priority). In this way, the application 115 may use the roaming rules 133 to create a prioritized list of roaming network systems 109A, 109B, 109C, and 109D as the custom PRL 125.

At operation 324, the application 115 may then generate a UI 121 for each of the roaming network systems 109A, 109B, 109C, and 109D based on the roaming data 130 received for each of the roaming network systems 109A, 109B, 109C, and 109D and the location data 169 of the UE 103. Operation 324 may be performed similar to operation 221 of method 200, except that the generation of the UIs 121 for each of the roaming network systems 109A, 109B, 109C, and 109D may be based on the ordered list of roaming network systems 109A, 109B, 109C, and 109D indicated in the custom PRL 125. The application 115 may display each UI 121 for each of the roaming network systems 109A, 109B, 109C, and 109D based on the ordered list of roaming network systems 109A, 109B, 109C, and 109D indicated in the custom PRL 125 (e.g., the first displayed UI 121 may be a roaming service plan offered by the highest priority roaming network system 109A, 109B, 109C, or 109D, and so on). After the UIs 121 are generated and displayed at the UE 103, method 300 may proceed with operations 224, 230, and 233 of method 200.

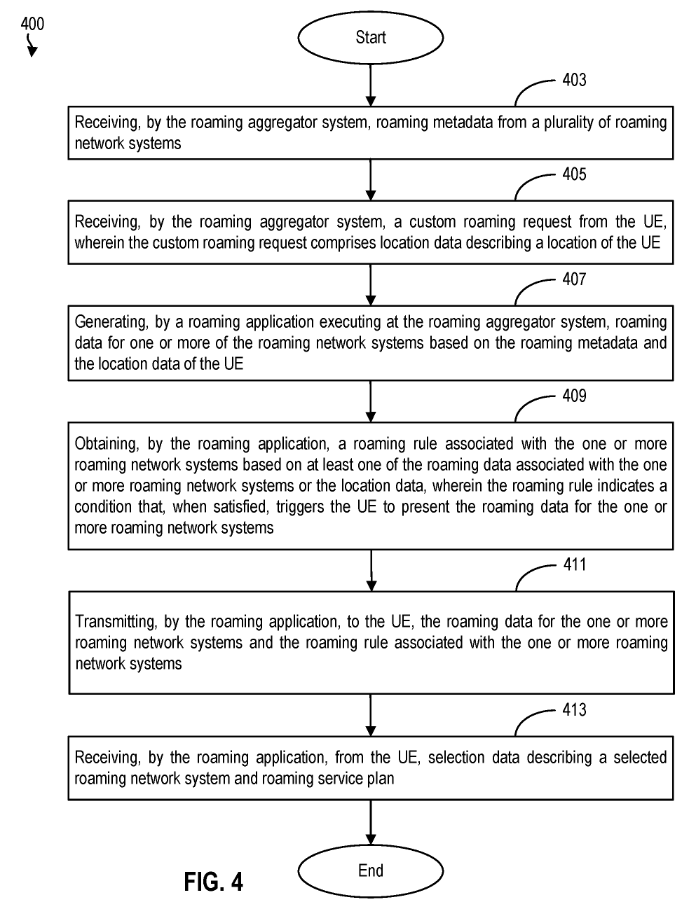

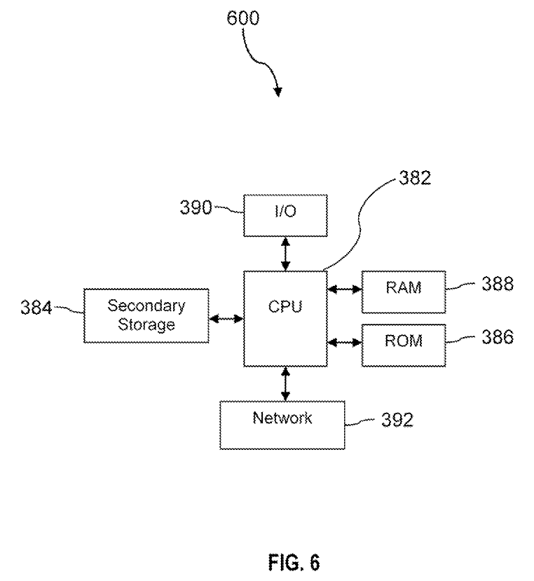

Referring now to FIG. 4, shown is a flowchart illustrating a first method 400 for customizing roaming at a UE 103 according to various embodiments of the disclosure. Method 400 may be performed by a computer system, such as the computer system 600 of FIG. 6. Method 400 may be performed by multiple roaming network systems (e.g., roaming network system 109 and/or one or more of the roaming network systems 109A, 109B, 109C, and/or 109D), the roaming aggregator system 106, and the UE 103. As illustrated, method 400 of FIG. 4 includes a number of enumerated operations, but embodiments of the operations in FIG. 4 may include additional operations before, after, and in between the enumerated operations. In some embodiments, one or more of the enumerated operations may be omitted or performed in a different order.

At step 403, method 400 comprises receiving, by the roaming aggregator system 106, roaming metadata 146 from a plurality of roaming network systems. At step 405, method 400 comprises receiving, by the roaming aggregator system 106, a custom roaming request from the UE 103. The custom roaming request comprises location data 169 describing a location of the UE 103. At step 407, method 400 comprises generating, by a roaming application 140 executing at the roaming aggregator system 106, roaming data 130 for one or more of the roaming network systems based on the roaming metadata 146 and the location data 169 of the UE 103.

At step 409, method 400 comprises obtaining, by the roaming application 140, a roaming rule 133 associated with the one or more roaming network systems based on at least one of the roaming data 130 associated with the one or more roaming network systems or the location data 169. The roaming rule 133 indicates a condition that, when satisfied, triggers the UE 103 to present the roaming data 130 for the one or more roaming network systems on a display 118 of the UE 103. At step 411, method 400 comprises transmitting, by the roaming application 140, to the UE 103, the roaming data 130 for the one or more roaming network systems and the roaming rule 133 associated with the one or more roaming network systems (in some cases for the UE 103 to display the roaming data 130 for each respective roaming network system with a selectable icon). At step 413, method 400 comprises receiving, by the roaming application 140, from the UE 103, selection data 172 describing a selected roaming network system and roaming service plan (e.g., selected by a user of the UE 103).

Method 400 may include other steps and/or features that are not otherwise shown in FIG. 4. In an embodiment, the roaming metadata 146 comprises at least one of an identifier 143 of a roaming network system, one or more roaming service plans offered by the roaming network system, a payment plan with the roaming network system, a permitted authentication method with the roaming network system, or one or more network attributes provided by the roaming network system. In an embodiment, a first roaming service plan of the one or more roaming service plans indicate a first predefined number of minutes, a first predefined amount of data, a period of time, and a first payment amount, and a second roaming service plan of the one or more roaming service plans indicate a second predefined number of minutes, a second predefined amount of data, a period of time, and a second payment amount.

In an embodiment, wherein the roaming data 130 for the one or more roaming network systems includes cell site data 158 describing locations of cell sites associated with the respective roaming network system and a coverage data 161 describing coverage areas of the cell sites at different geographical locations. In an embodiment, the location data 169 of the UE 103 is based on latitude and longitude coordinates of the UE 103 or a location of a cell site attached to the UE 103. In an embodiment, the roaming rule 133 comprises logic or code indicating that when the condition associated with the respective roaming network system is satisfied, a client application 115 at the UE 103 is instructed to present or refrain from presenting the roaming data 130 for the respective roaming network system. In an embodiment, the roaming data 130 is further generated using a trained large language model.

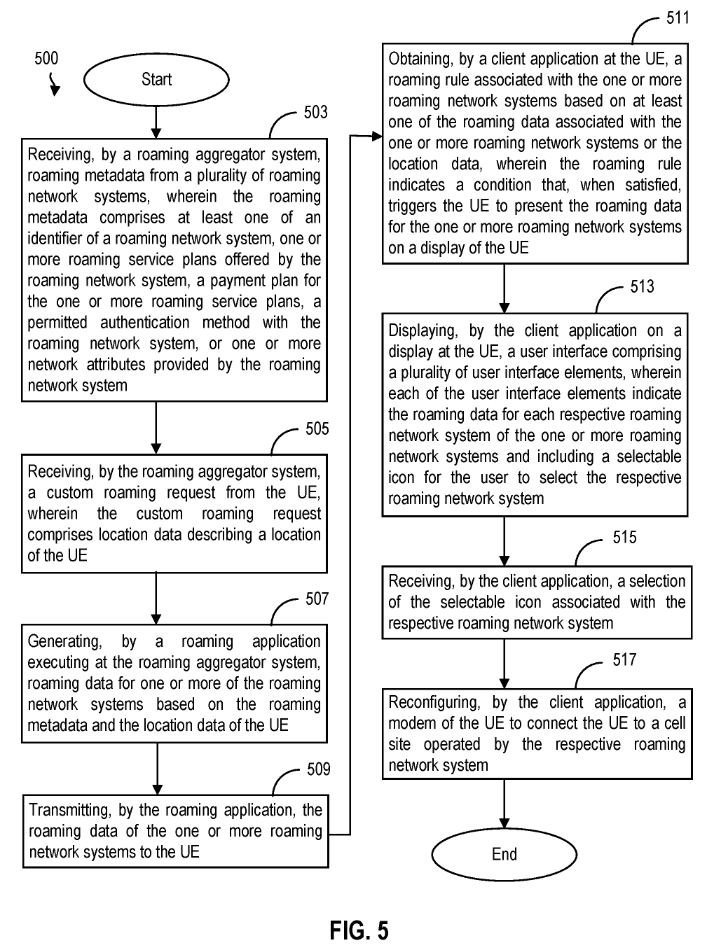

Referring now to FIG. 5, shown is a flowchart illustrating a second method 500 for customizing roaming at a UE 103 according to various embodiments of the disclosure. Method 500 may be performed by a computer system, such as the computer system 600 of FIG. 6. Method 500 may be performed by multiple roaming network systems (e.g., roaming network system 109 and/or one or more of the roaming network systems 109A, 109B, 109C, and/or 109D), the roaming aggregator system 106, and the UE 103. As illustrated, method 500 of FIG. 5 includes a number of enumerated operations, but embodiments of the operations in FIG. 5 may include additional operations before, after, and in between the enumerated operations. In some embodiments, one or more of the enumerated operations may be omitted or performed in a different order.

At step 503, method 500 comprises receiving, by a roaming aggregator system 106, roaming metadata 146 from a plurality of roaming network systems. The roaming metadata 146 comprises at least one of an identifier 143 of a roaming network system, one or more roaming service plans offered by the roaming network system, a payment plan for the one or more roaming service plans, a permitted authentication method with the roaming network system, or one or more network attributes provided by the roaming network system. At step 505, method 500 comprises receiving, by the roaming aggregator system 106, a custom roaming request from the UE 103, in which the custom roaming request comprises location data 169 describing a location of the UE 103.

At step 507, method 500 comprises generating, by a roaming application 140 executing at the roaming aggregator system 106, roaming data 130 for one or more of the roaming network systems based on the roaming metadata 146 and the location data 169 of the UE 103. At step 509, method 500 comprises transmitting, by the roaming application 140, the roaming data 130 of the one or more roaming network systems to the UE 103. At step 511, method 500 comprises obtaining, by a client application 115 at the UE 103, a roaming rule 133 associated with the one or more roaming network systems based on at least one of the roaming data 130 associated with the one or more roaming network systems or the location data 169. The roaming rule 133 indicates a condition, when satisfied, that triggers the UE 103 to present the roaming data 130 for the one or more roaming network systems on a display 118 of the UE 103.

At step 513, method 500 comprises displaying, by the client application 115 on a display at the UE 103, a UI 121 comprising a plurality of user interface elements. Each of the user interface elements indicate the roaming data 130 for each respective roaming network system of the one or more roaming network systems and including a selectable icon for the user to select the respective roaming network system. At step 515, method 500 comprises receiving, by the client application 115, a selection of the selectable icon associated with the respective roaming network system. At step 517, method 500 comprises reconfiguring, by the client application 115, a modem of the UE 103 to connect the UE 103 to a cell site operated by the respective roaming network system.

Method 500 may include other steps and/or features that are not otherwise shown in FIG. 5. In an embodiment, a roaming service plan of the one or more roaming service plans indicate a predefined number of minutes, a predefined amount of data, a period of time, and a payment amount. In an embodiment, the one or more network attributes comprise at least one of a minimum quality of service or a frequency band for communications. In an embodiment, the roaming data 130 for the one or more roaming network systems comprise roaming configurations for one or more UEs 103 to detach from a home network system 110 and instead connect to a radio access network operated by the respective roaming network system. In an embodiment, the roaming rule 133 is based on user preferences 175 associated with the UE 103. In an embodiment, the roaming rule 133 is programmed into firmware of the UE 103 based on user preferences 175 received at the UE 103.

FIG. 6 illustrates a computer system 600 suitable for implementing one or more embodiments disclosed herein. In an embodiment, the UE 103, each roaming network system, home network system 110, and/or the roaming aggregator system 106, may each be implemented as the computer system 600. The computer system 600 includes a processor 382 (which may be referred to as a central processor unit or CPU) that is in communication with memory devices including secondary storage 384, read only memory (ROM) 386, random access memory (RAM) 388, input/output (I/O) devices 390, and network connectivity devices 392. The processor 382 may be implemented as one or more CPU chips.

It is understood that by programming and/or loading executable instructions onto the computer system 600, at least one of the CPU 382, the RAM 388, and the ROM 386 are changed, transforming the computer system 600 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 600 is turned on or booted, the CPU 382 may execute a computer program or application. For example, the CPU 382 may execute software or firmware stored in the ROM 386 or stored in the RAM 388. In some cases, on boot and/or when the application is initiated, the CPU 382 may copy the application or portions of the application from the secondary storage 384 to the RAM 388 or to memory space within the CPU 382 itself, and the CPU 382 may then execute instructions that the application is comprised of. In some cases, the CPU 382 may copy the application or portions of the application from memory accessed via the network connectivity devices 392 or via the I/O devices 390 to the RAM 388 or to memory space within the CPU 382, and the CPU 382 may then execute instructions that the application is comprised of. During execution, an application may load instructions into the CPU 382, for example load some of the instructions of the application into a cache of the CPU 382. In some contexts, an application that is executed may be said to configure the CPU 382 to do something, e.g., to configure the CPU 382 to perform the function or functions promoted by the subject application. When the CPU 382 is configured in this way by the application, the CPU 382 becomes a specific purpose computer or a specific purpose machine.

The secondary storage 384 is typically comprised of one or more disk drives or tape drives and is used for non-volatile storage of data and as an over-flow data storage device if RAM 388 is not large enough to hold all working data. Secondary storage 384 may be used to store programs which are loaded into RAM 388 when such programs are selected for execution. The ROM 386 is used to store instructions and perhaps data which are read during program execution. ROM 386 is a non-volatile memory device which typically has a small memory capacity relative to the larger memory capacity of secondary storage 384. The RAM 388 is used to store volatile data and perhaps to store instructions. Access to both ROM 386 and RAM 388 is typically faster than to secondary storage 384. The secondary storage 384, the RAM 388, and/or the ROM 386 may be referred to in some contexts as computer readable storage media and/or non-transitory computer readable media.

I/O devices 390 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 392 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards, and/or other well-known network devices. The network connectivity devices 392 may provide wired communication links and/or wireless communication links (e.g., a first network connectivity device 392 may provide a wired communication link and a second network connectivity device 392 may provide a wireless communication link). Wired communication links may be provided in accordance with Ethernet (IEEE 802.3), Internet protocol (IP), time division multiplex (TDM), data over cable service interface specification (DOCSIS), wavelength division multiplexing (WDM), and/or the like. In an embodiment, the radio transceiver cards may provide wireless communication links using protocols such as code division multiple access (CDMA), global system for mobile communications (GSM), long-term evolution (LTE), WiFi (IEEE 802.11), Bluetooth, Zigbee, narrowband Internet of things (NB IoT), near field communications (NFC), and radio frequency identity (RFID). The radio transceiver cards may promote radio communications using 5G, 5G New Radio, or 5G LTE radio communication protocols. These network connectivity devices 392 may enable the processor 382 to communicate with the Internet or one or more intranets. With such a network connection, it is contemplated that the processor 382 might receive information from the network, or might output information to the network in the course of performing the above-described method steps. Such information, which is often represented as a sequence of instructions to be executed using processor 382, may be received from and outputted to the network, for example, in the form of a computer data signal embodied in a carrier wave.

Such information, which may include data or instructions to be executed using processor 382 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 382 executes instructions, codes, computer programs, scripts which it accesses from hard disk, floppy disk, optical disk (these various disk based systems may all be considered secondary storage 384), flash drive, ROM 386, RAM 388, or the network connectivity devices 392. While only one processor 382 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 384, for example, hard drives, floppy disks, optical disks, and/or other device, the ROM 386, and/or the RAM 388 may be referred to in some contexts as non-transitory instructions and/or non-transitory information.

In an embodiment, the computer system 600 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 600 to provide the functionality of a number of servers that is not directly bound to the number of computers in the computer system 600. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third-party provider. Some cloud computing environments may comprise cloud computing resources owned and operated by the enterprise as well as cloud computing resources hired and/or leased from a third-party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 600, at least portions of the contents of the computer program product to the secondary storage 384, to the ROM 386, to the RAM 388, and/or to other non-volatile memory and volatile memory of the computer system 600. The processor 382 may process the executable instructions and/or data structures in part by directly accessing the computer program product, for example by reading from a CD-ROM disk inserted into a disk drive peripheral of the computer system 600. Alternatively, the processor 382 may process the executable instructions and/or data structures by remotely accessing the computer program product, for example by downloading the executable instructions and/or data structures from a remote server through the network connectivity devices 392. The computer program product may comprise instructions that promote the loading and/or copying of data, data structures, files, and/or executable instructions to the secondary storage 384, to the ROM 386, to the RAM 388, and/or to other non-volatile memory and volatile memory of the computer system 600.

In some contexts, the secondary storage 384, the ROM 386, and the RAM 388 may be referred to as a non-transitory computer readable medium or a computer readable storage media. A dynamic RAM embodiment of the RAM 388, likewise, may be referred to as a non-transitory computer readable medium in that while the dynamic RAM receives electrical power and is operated in accordance with its design, for example during a period of time during which the computer system 600 is turned on and operational, the dynamic RAM stores information that is written to it. Similarly, the processor 382 may comprise an internal RAM, an internal ROM, a cache memory, and/or other internal non-transitory storage blocks, sections, or components that may be referred to in some contexts as non-transitory computer readable media or computer readable storage media.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A method implemented in a communication system to customize roaming at a user equipment (UE), wherein the method comprises:
receiving, by a roaming aggregator system, roaming metadata from a plurality of roaming network systems, wherein the roaming metadata comprises at least one of an identifier of a roaming network system, one or more roaming service plans offered by the roaming network system, a payment plan for the one or more roaming service plans, a permitted authentication method with the roaming network system, or one or more network attributes provided by the roaming network system;
receiving, by the roaming aggregator system, a custom roaming request from the UE, wherein the custom roaming request comprises location data describing a location of the UE;
generating, by a roaming application executing at the roaming aggregator system, roaming data for one or more of the roaming network systems based on the roaming metadata and the location data of the UE;
transmitting, by the roaming application, the roaming data of the one or more roaming network systems to the UE;
obtaining, by a client application at the UE, a roaming rule associated with the one or more roaming network systems based on at least one of the roaming data associated with the one or more roaming network systems or the location data, wherein the roaming rule indicates a condition that, when satisfied, triggers the UE to present the roaming data for the one or more roaming network systems on a display of the UE;
displaying, by the client application on a display at the UE, a user interface comprising a plurality of user interface elements, wherein each of the user interface elements indicate the roaming data for each respective roaming network system of the one or more roaming network systems and including a selectable icon for a user to select the respective roaming network system;
receiving, by the client application, a selection of the selectable icon associated with the respective roaming network system; and
reconfiguring, by the client application, a modem of the UE to connect the UE to a cell site operated by the respective roaming network system.

2. The method of claim 1, wherein a roaming service plan of the one or more roaming service plans indicate a predefined number of minutes, a predefined amount of data, a period of time, and a payment amount.

3. The method of claim 1, wherein the one or more network attributes comprise at least one of a minimum quality of service or a frequency band for communications.

4. The method of claim 1, wherein the roaming data for the one or more roaming network systems comprise roaming configurations for one or more UEs to detach from a home network system and instead connect to a radio access network operated by the respective roaming network system.

5. The method of claim 4, wherein the roaming rule is based on user preferences associated with the UE.

6. The method of claim 1, wherein the roaming rule is programmed into firmware of the UE based on user preferences received at the UE.

7. A method implemented by a roaming aggregator system to customize roaming at a user equipment (UE), wherein the method comprises:
receiving, by the roaming aggregator system, roaming metadata from a plurality of roaming network systems;
receiving, by the roaming aggregator system, a custom roaming request from the UE, wherein the custom roaming request comprises location data describing a location of the UE;
generating, by a roaming application executing at the roaming aggregator system, roaming data for one or more of the roaming network systems based on the roaming metadata and the location data of the UE;
obtaining, by the roaming application, a roaming rule associated with the one or more roaming network systems based on at least one of the roaming data associated with the one or more roaming network systems or the location data, wherein the roaming rule indicates a condition that, when satisfied, triggers the UE to present the roaming data for the one or more roaming network systems;
transmitting, by the roaming application, to the UE, the roaming data for the one or more roaming network systems and the roaming rule associated with the one or more roaming network systems for the UE to display the roaming data for each respective roaming network system with a selectable icon; and
receiving, by the roaming application, from the UE, selection data describing a selected roaming network system and roaming service plan.

8. The method of claim 7, wherein the roaming metadata comprises at least one of an identifier of a roaming network system, one or more roaming service plans offered by the roaming network system, a payment plan with the roaming network system, a permitted authentication method with the roaming network system, or one or more network attributes provided by the roaming network system.

9. The method of claim 8, wherein a first roaming service plan of the one or more roaming service plans indicate a first predefined number of minutes, a first predefined amount of data, a period of time, and a first payment amount, and wherein a second roaming service plan of the one or more roaming service plans indicate a second predefined number of minutes, a second predefined amount of data, a period of time, and a second payment amount.

10. The method of claim 7, wherein the roaming data for the one or more roaming network systems includes cell site data describing locations of cell sites associated with the selected roaming network system and a coverage area data describing coverage areas of the cell sites at different geographical locations.

11. The method of claim 7, wherein the location data of the UE is based on latitude and longitude coordinates of the UE or a location of a cell site attached to the UE.

12. The method of claim 7, wherein the roaming rule comprises logic or code indicating that when the condition associated with the selected roaming network system is satisfied, a client application at the UE is instructed to present or refrain from presenting the roaming data for the selected roaming network system.

13. The method of claim 7, wherein the roaming data is further generated using a trained large language model.

14. A user equipment (UE), comprising:
at least one processor;
at least one memory coupled to the processor; and
a client application, stored in the at least one memory, which when executed by the at least one processor, causes the client application to be configured to:
receive roaming data for a plurality of roaming network systems from a roaming aggregator system, an identifier of each of the roaming network systems, and one or more roaming service plans offered by each of the roaming network systems;
obtain a roaming rule associated with each of the roaming network systems based on at least one of the roaming data associated with each of coverage datathe roaming network systems or location data describing a location of the UE; and
display a user interface comprising a plurality of user interface elements each corresponding to a respective roaming network system, wherein each of the user interface elements indicate the roaming data for the respective roaming network system and include a selectable icon for the user to select the respective roaming network system.

15. The UE of claim 14, wherein the roaming data further comprises a payment plan with a roaming network system, one or more network attributes provided by the roaming network system, locations of cell sites associated with the roaming network system, or coverage areas offered by the roaming network system at different geographic locations.

16. The UE of claim 14, wherein the roaming rule indicates a condition to present the roaming data for the respective roaming network system on a display of the UE.

17. The UE of claim 14, wherein the client application is further configured to receive a selection of the selectable icon associated with the respective roaming network system.

18. The UE of claim 17, wherein after the selection of the selectable icon is received, the client application is further configured to reconfigure a modem of the UE to connect the UE to a cell site operated by the respective roaming network system.

19. The UE of claim 14, wherein the client application is further configured to transmit, to the roaming aggregator system, selection data describing the respective roaming network system and a selected roaming service plan selected by a user of the UE.

20. The UE of claim 14, wherein the roaming rule comprises logic or code indicating that when a condition associated with the respective roaming network system is satisfied, the client application is instructed to present or refrain from presenting the roaming data for the respective roaming network system.
